(19) United States
(12) Patent Application Publication
(10) Pub. No.: US 2017/0053745 A1
(43) Pub. Date: Feb. 23, 2017

(54) ELECTROLYTIC CAPACITOR MANUFACTURING METHOD

(71) Applicant: Panasonic Intellectual Property Management Co., Ltd., Osaka (JP)

(72) Inventors: TATSUJI AOYAMA, Yamaguchi (JP); TOMOYUKI TASHIRO, Yamaguchi (JP); YUICHI NAKAJIMA, Yamaguchi (JP); HIROFUMI MARUYAMA, Yamaguchi (JP)

(21) Appl. No.: 15/343,414

(22) Filed: Nov. 4, 2016

Related U.S. Application Data
(63) Continuation of application No. PCT/JP2015/002344, filed on May 8, 2015.

(30) Foreign Application Priority Data
May 16, 2014 (JP) 2014-101940

(51) Int. Cl. H01G 9/00; H01G 9/008; H01G 9/07; H01G 9/10; H01G 9/02; H01G 9/145

(52) U.S. Cl. CPC H01G 9/0029; H01G 9/02; H01G 9/145; H01G 9/07; H01G 9/10; H01G 9/008

(57) ABSTRACT

A method for manufacturing an electrolytic capacitor includes preparing a capacitor element that includes an anode body having a dielectric layer, and a separator including a cellulose fiber; impregnating the capacitor element with a first treatment solution containing a first solvent and conductive polymer particles; and impregnating, after impregnating the capacitor element with the first treatment solution, the capacitor element with a second treatment solution containing a second solvent at a state where the capacitor element includes the first solvent.

### RELATED APPLICATIONS

This application is a Continuation of International Application No. PCT/JP2015/002344, filed on May 8, 2015, which in turn claims priority from Japanese Patent Application No. 2014-101940, filed on May 16, 2014, the contents of all of which are incorporated herein by reference in their entireties.

### BACKGROUND

1. Technical Field

The present disclosure relates to a method for manufacturing an electrolytic capacitor having low equivalent series resistance (ESR) characteristics.

2. Description of the Related Art

Along with digitalization of electronic devices, compactification, large capacitance and low ESR in a high frequency range have been required of capacitors used in the electronic devices.

Conventionally, plastic film capacitors, laminated ceramic capacitors, and the like are used as capacitors for a high frequency range in many cases, but these capacitors have relatively small capacitance.

Promising candidates as small-sized, large capacitance, and low ESR capacitors are electrolytic capacitors including as a cathode material a conductive polymer such as polypyrrole, polythiophene, polyfuran, or polyaniline Proposed is, for example, an electrolytic capacitor including anode foil having a dielectric layer (anode body), and a conductive polymer layer as a cathode material provided on the anode foil.

Unexamined Japanese Patent Publication No. 2008-010657 proposes a method for obtaining an electrolytic capacitor including a conductive solid layer and an electrolyte solution by impregnating a separator-equipped element with a conductive polymer dispersion to form a conductive solid layer, followed by impregnation with the electrolyte solution.

### SUMMARY

A method for manufacturing an electrolytic capacitor according to the present disclosure includes preparing a capacitor element that includes an anode body having a dielectric layer, and a separator including a cellulose fiber; impregnating the capacitor element with a first treatment solution containing a first solvent and conductive polymer particles; and impregnating, after impregnating the capacitor element with the first treatment solution, the capacitor element with a second treatment solution containing a second solvent at a state where the capacitor element includes the first solvent.

According to the present disclosure, an electrolytic capacitor having reduced ESR and leakage current can be obtained.

### BRIEF DESCRIPTION OF THE DRAWINGS

FIG. 1 is a schematic sectional view of an electrolytic capacitor according to an exemplary embodiment of the present disclosure;

FIG. 2 is a schematic view illustrating a configuration of a capacitor element according to the present exemplary embodiment; and

FIG. 3 is a diagram showing a process for manufacturing an electrolytic capacitor according to the exemplary embodiment.

### DETAILED DESCRIPTION OF EMBODIMENTS

In recent years, further reduction in ESR is required. Particularly, when a separator including a cellulose fiber is used, it is difficult for particles of a conductive polymer to reach a surface of an anode body so that a dielectric layer cannot be adequately covered with the conductive polymer, causing high ESR. In order to solve the problem described above, the present disclosure provides a method for manufacturing an electrolytic capacitor that can give an electrolytic capacitor having reduced ESR and leakage current. Hereinafter, an exemplary embodiment of the present disclosure is described with reference to the drawings.

### <<Electrolytic Capacitor>>

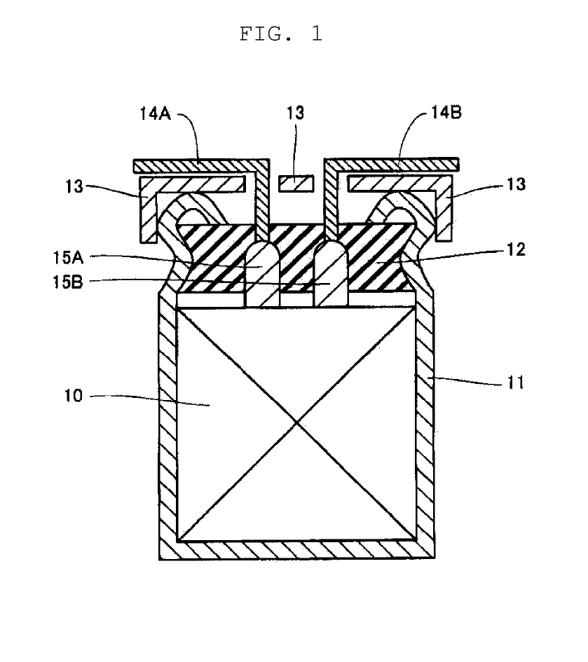

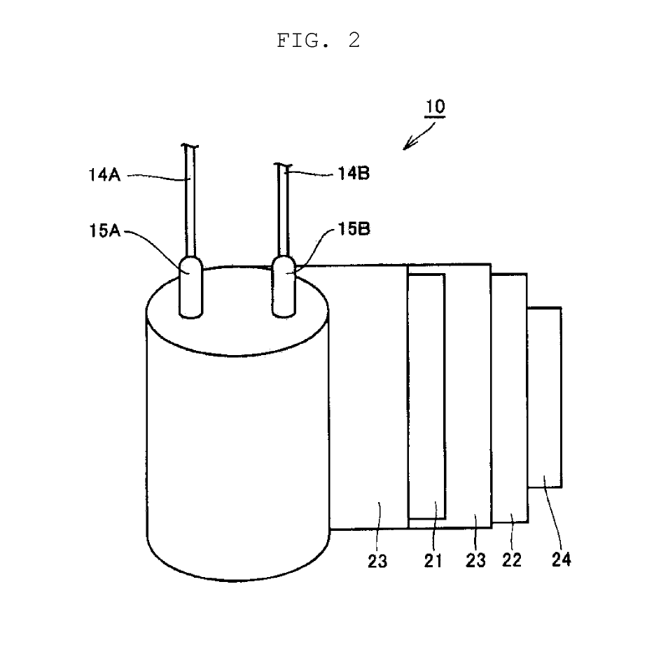

FIG. 1 is a schematic sectional view of an electrolytic capacitor according to the present exemplary embodiment, and FIG. 2 is a schematic view showing a part of a capacitor element included in the electrolytic capacitor according to the present exemplary embodiment.

The electrolytic capacitor includes capacitor element 10, bottomed case 11 for housing capacitor element 10, sealing member 12 for sealing an opening of bottomed case 11, base plate 13 for covering sealing member 12, lead wires 14A, 14B that extend from sealing member 12 and penetrate base plate 13, and lead tabs 15A, 15B for connecting the lead wires to electrodes of capacitor element 10, respectively. Bottomed case 11 is, at a part near an opening end, processed inward by drawing, and is, at the opening end, swaged to sealing member 12 for curling.

Capacitor element 10 includes an anode body having a dielectric layer, and a separator. For example, capacitor element 10 may include lead tab 15A connected to anode body 21 and lead tab 15B connected to cathode body 22 as shown in FIG. 2. In this case, anode body 21 and cathode body 22 are laminated with separator 23 interposed between the anode body and the cathode body and are wound. An outermost periphery of capacitor element 10 is fixed with fastening tape 24. FIG. 2 shows partially developed capacitor element 10 before the outermost periphery of the capacitor element is fixed.

Anode body 21 includes metal foil whose surface is roughened so as to have projections and recesses, and a dielectric layer is formed on the metal foil having the projections and recesses. A conductive polymer is attached to at least a part of a surface of the dielectric layer to form a conductive polymer layer. The conductive polymer layer may cover at least a part of a surface of cathode body 22 and/or a surface of separator 23. Capacitor element 10 in which conductive polymer layer is formed may be housed together with an electrolyte solution in an outer case including bottomed case 11, sealing member 12, and the like.

### <<Method for Manufacturing Electrolytic Capacitor>>

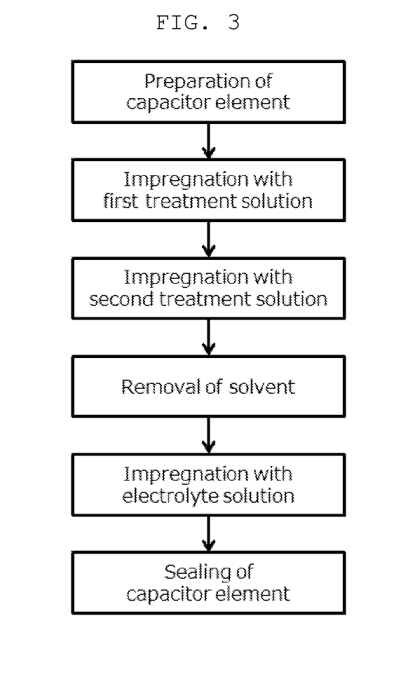

FIG. 3 is a diagram showing a process for manufacturing an electrolytic capacitor according to the present exemplary embodiment. Hereinafter, an example of the method for manufacturing an electrolytic capacitor according to the present exemplary embodiment is described step by step.

### (i) Step of Preparing Capacitor Element (First Step)

First, a raw material of anode body 21, i.e. metal foil is prepared. A type of a metal is not particularly limited, but it is preferable to use a valve metal such as aluminum, tantalum, or niobium, or an alloy including a valve metal, from the viewpoint of facilitating formation of a dielectric layer.

Next, a surface of the metal foil is roughened. By the roughening, a plurality of projections and recesses are formed on the surface of the metal foil. The roughening is preferably performed by etching the metal foil. The etching may be performed by, for example, a DC electrolytic method or an AC electrolytic method.

Next, a dielectric layer is formed on the roughened surface of the metal foil. A method for forming the dielectric layer is not particularly limited, but the dielectric layer can be formed by subjecting the metal foil to an anodizing treatment. The anodizing treatment may be, for example, a technique of immersing the metal foil in an anodizing solution such as an ammonium adipate solution, followed by application of a voltage.

Generally, large foil of, for example, a valve metal (metal foil) is subjected to a roughening treatment and an anodizing treatment from the viewpoint of mass productivity. In this case, the treated foil is cut into a desired size to prepare anode body 21.

Further, cathode body 22 is prepared. Cathode body 22 may also be made of metal foil as with the anode body. A type of a metal is not particularly limited, but it is preferable to use a valve metal such as aluminum, tantalum, or niobium, or an alloy including a valve metal. A surface of cathode body 22 may be roughened as necessary. Further, on the surface of cathode body 22 may be formed an anodizing film, a film of a metal different from a metal that constitutes the cathode body (different type of metal), or a nonmetal film. Examples of the different type of metal and the nonmetal include metals such as titanium and nonmetals such as carbon.

Next, capacitor element 10 is produced with anode body 21 and cathode body 22.

First, anode body 21 and cathode body 22 are wound with separator 23 interposed between the anode body and the cathode body. At this time, anode body 21 and cathode body 22 are wound while lead tabs 15A, 15B connected to the electrodes are rolled in the electrodes and the separator, to cause lead tabs 15A, 15B to stand up from capacitor element 10 as shown in FIG. 2.

Separator 23 includes a cellulose fiber. The cellulose fiber is a generic term of fibers having cellulose as a main component, and includes, in addition to natural fibers obtained from natural materials such as Manila hemp, esparto, hemp, kraft pulp, and bamboo, recycled fibers such as rayon, which can be obtained by once dissolving these natural materials followed by spinning, and semisynthetic fibers such as acetate, which can be obtained by subjecting the natural materials to a chemical treatment. Separator 23 may include a fiber other than the cellulose fiber, such as a polyethylene terephthalate fiber, a vinylon fiber, or a polyamide fiber (an aliphatic polyamide fiber such as nylon and an aromatic polyamide fiber such as aramid). The cellulose fiber preferably accounts for 50% by mass or more of fibers included in the separator. Preferably, fibrillation (fiber separation) is not caused in the cellulose fiber. This is because a non-fibrillated fiber facilitates movement of the conductive polymer particles, allowing the conductive polymer particles to easily reach the dielectric layer.

An air permeability of separator 23 preferably ranges from 1 s/100 ml to 150 s/100 ml (both inclusive), more preferably from 1 s/100 ml to 60 s/100 ml (both inclusive). A separator having an air permeability in this range facilitates movement of the conductive polymer particles, allowing the conductive polymer particles to easily reach the dielectric layer. The air permeability is measured by a Gurley air permeability tester according to JIS P8117. A thickness of separator 23 preferably ranges from 10 μm to 100 μm (both inclusive). Separator 23 having a thickness in this range increases an effect of suppressing a short circuit of the electrolytic capacitor.

A material of lead tabs 15A, 15B is not particularly limited as long as the material is a conductive material. Surfaces of lead tabs 15A, 15B may be subjected to an anodizing treatment. Further, lead tabs 15A, 15B may be covered with a resin material at a part in contact with sealing member 12 and a part connected to lead wires 14A, 14B.

A material of lead wires 14A, 14B connected to lead tabs 15A, 15B, respectively, is not also particularly limited as long as the material is a conductive material.

Then, fastening tape 24 is disposed on an outer surface of cathode body 22 positioned at an outermost layer among wound anode body 21, cathode body 22, and separator 23 to fix an end of cathode body 22 with fastening tape 24. When anode body 21 is prepared by cutting large metal foil, capacitor element 10 may be further subjected to an anodizing treatment in order to provide a dielectric layer on a cut surface of anode body 21.

(ii) Step of Impregnating Capacitor Element with First Treatment Solution (Second Step)

Next, capacitor element 10 is impregnated with a first treatment solution.

A method for impregnating capacitor element 10 with the first treatment solution is not particularly limited. Examples of the usable method include a method for immersing capacitor element 10 in the first treatment solution contained in a vessel and a method for dropping the first treatment solution onto capacitor element 10. An impregnation period depends on a size of capacitor element 10, but ranges, for example, from 1 second to 5 hours (both inclusive), preferably from 1 minute to 30 minutes (both inclusive). Further, the impregnation may be conducted in an atmosphere under a reduced pressure ranging, for example, from 10 kPa to 100 kPa (both inclusive), preferably from 40 kPa to 100 kPa (both inclusive). Further, ultrasonic vibration may be applied to capacitor element 10 or the first treatment solution while capacitor element 10 is impregnated with the first treatment solution. By this step, the first treatment solution is applied to capacitor element 10.

Examples of the conductive polymer include polypyrrole, polythiophene, polyfuran, polyaniline, polyacetylene, polyphenylene, polyphenylene vinylene, polyacene, and polythiophene vinylene. A single one or a combination of two or more of these conductive polymers may be used, or a copolymer of two or more monomers may also be used.

In the present specification, polypyrrole, polythiophene, polyfuran, polyaniline, and the like mean polymers having, as a basic skeleton, polypyrrole, polythiophene, polyfuran, polyaniline, and the like, respectively. Therefore, polypyrrole, polythiophene, polyfuran, polyaniline, and the like also include their derivatives. For example, polythiophene includes poly(3,4-ethylene dioxythiophene).

The conductive polymer contained in the first treatment solution is, in a state of particles, dispersed in a dispersion solvent containing a first solvent. The first treatment solution can be obtained by, for example, a method for dispersing the conductive polymer particles in the dispersion solvent containing the first solvent, or a method for polymerizing a precursor monomer of the conductive polymer in the dispersion solvent containing the first solvent to generate the conductive polymer particles in the dispersion solvent containing the first solvent.

The conductive polymer may include a dopant. As the dopant, a polyanion may be used. Specific examples of the polyanion include anions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. A polyanion derived from polystyrenesulfonic acid is especially preferable. A single one or a combination of two or more of these polyanions may be used. These polyanions may be a polymer of a single monomer or a copolymer of two or more monomers.

A weight average molecular weight of the polyanion is not particularly limited, but ranges, for example, from 1,000 to 1,000,000 (both inclusive). A conductive polymer including such a polyanion is easily and uniformly dispersed in the dispersion solvent containing the first solvent, facilitating uniform attachment of the conductive polymer to the surface of the dielectric layer.

The conductive polymer particles preferably have a median diameter of 80 nm or more in a volume particle size distribution obtained by measurement with a particle diameter measuring apparatus according to dynamic light scattering (hereinafter, simply referred to as a median diameter according to dynamic light scattering). A particle diameter of the conductive polymer can be adjusted by polymerization conditions and dispersion conditions. In the present disclosure, the conductive polymer particles can reach a surface of anode body 21 even when the particles have such a large particle diameter, and the separator includes cellulose. Reasons for this are described later.

A concentration of the conductive polymer (including a dopant or a polyanion) in the first treatment solution preferably ranges from 0.5% by mass to 10% by mass (both inclusive). The first treatment solution having such a concentration is suitable for attachment of an appropriate amount of the conductive polymer and is easily impregnated into capacitor element 10 to also give advantages for productivity improvement.

The dispersion solvent in the first treatment solution has only to contain at least the first solvent, and the dispersion solvent may also contain another solvent other than the first solvent. The first solvent may account for, for example, 30% by mass or more, preferably 50% by mass or more, more preferably 70% by mass or more of the dispersion solvent in the first treatment solution.

The first solvent is not particularly limited, and may be water or a nonaqueous solvent. The nonaqueous solvent is a generic term of liquids except water and liquids containing water, and includes an organic solvent and an ionic liquid. As the first solvent, a polar solvent is especially preferable. The polar solvent may be a protic solvent or an aprotic solvent.

Examples of the protic solvent include alcohols such as methanol, ethanol, propanol, butanol, ethylene glycol (EG), propylene glycol, polyethylene glycol (PEG), diethylene glycol monobutyl ether, glycerin, 1-propanol, butanol, and polyglycerin, formaldehyde, and water. Examples of the aprotic solvent include amides such as N-methylacetamide, N,N-dimethylformamide, and N-methyl-2-pyrrolidone; esters such as methyl acetate; ketones such as methyl ethyl ketone and γ-butyrolactone (γBL); ethers such as 1,4-dioxane sulfur-containing compounds such as dimethylsulfoxide and sulfolane; and carbonate compounds such as propylene carbonate.

As the first solvent, a protic solvent is especially preferable. This is because the cellulose fiber included in separator 23 has multiple OH groups and is therefore compatible with the protic solvent. Particularly, the first solvent is preferably water. In this case, handleability and dispersibility of the conductive polymer particles are improved. Further, water having low viscosity is expected to improve contact between the conductive polymer particles and a second solvent in a subsequent third step. When the first solvent is water, water preferably accounts for 50% by mass or more, more preferably 70% by mass or more, particularly preferably 90% by mass or more of the dispersion solvent in the first treatment solution.

The dispersion solvent contained in the first treatment solution may contain a plurality of different first solvents, or may contain, in addition to the first solvent, another solvent different from the first solvent.

(iii) Step of Impregnating Capacitor Element with Second Treatment Solution (Third Step)

Next, capacitor element 10, to which the first treatment solution has been applied, is impregnated with a second treatment solution to apply to capacitor element 10 the second treatment solution containing the second solvent.

Capacitor element 10 at least including a part of the first solvent is subjected to impregnation with the second treatment solution. Thereby, the conductive polymer particles easily reach the surface of the dielectric layer in the capacitor element to give advantages of reduced ESR and leakage current to the electrolytic capacitor.

When the conductive polymer particles contact the separator including the cellulose fiber, the conductive polymer particles are easily trapped by the separator on site. Therefore, a part of the conductive polymer particles does not tend to reach the surface of the dielectric layer in capacitor element 10 only by impregnating capacitor element 10 with the first treatment solution. When drying is conducted in this state to remove the dispersion solvent containing the first solvent, the part of the conductive polymer particles is easily solidified at a place (e.g. a surface of the separator) where the particles are trapped by separator 23. It is difficult for the conductive polymer particles, which have not reached the dielectric layer and have been solidified, to exhibit a function as a substantial cathode material, resulting in inadequate electrostatic capacitance and increasing ESR and leakage current.

In the present disclosure, capacitor element 10 that has been impregnated with the first treatment solution and thereby includes the first solvent is impregnated with the second treatment solution. That is, the conductive polymer has not been completely solidified in the step of impregnation with the second treatment solution, and the conductive polymer particles are present in a movable state from a place where the particles are trapped by separator 23. Then, the second solvent contained in the second treatment solution allows the conductive polymer particles to move so that the particles are pushed into voids of separator 23 to reach the surface of the dielectric layer in the capacitor element.

The effect described above is remarkable particularly when the separator has an air permeability ranging from 1 s/100 ml to 150 s/100 ml (both inclusive), further from 1 s/100 ml to 60 s/100 ml (both inclusive) and when a median diameter of the conductive polymer particles according to dynamic light scattering is 80 nm or more, further 120 nm or more. Small conductive polymer particles may cause insulation breakdown of the dielectric layer. Therefore, use of conductive polymer particles having a large particle diameter facilitates further reduction in ESR and a short circuit rate.

It is preferable that capacitor element 10 including 30% by mass or more of the first solvent applied to capacitor element 10 (in a state in which 30% by mass or more of the first solvent applied to capacitor element 10 remains in capacitor element 10) be subjected to impregnation with the second treatment solution.

When a remaining amount of the first solvent in capacitor element 10 is 30% by mass or more, the conductive polymer is not completely solidified, facilitating movement of the conductive polymer particles. The remaining amount is preferably 50% by mass or more, more preferably 60% by mass or more. Capacitor element 10 may be subjected to drying, such as drying by heat or drying under reduced pressure, to remove a part of the first solvent before the second treatment solution is applied to capacitor element 10.

A method for impregnating capacitor element 10 with the second treatment solution and applying the solution to the capacitor element is not particularly limited. Examples of the method include a method for immersing capacitor element 10 in the second treatment solution, a method for dropping the second treatment solution onto capacitor element 10, and a method for coating capacitor element 10 with the second treatment solution.

The second treatment solution contains at least the second solvent. The second solvent preferably accounts for 30% by mass or more, more preferably 50% by mass or more, particularly preferably 70% by mass or more of a whole solvent contained in the second treatment solution. The second solvent is not particularly limited, and may be the same or different from the first solvent. Examples of the second solvent include the same solvents as exemplified for the first solvent. That is, the second solvent may be water or a nonaqueous solvent. Especially, the second solvent is preferably a polar solvent. The polar solvent may be a protic solvent or an aprotic solvent. For example, when the first solvent is a protic solvent, it is preferable to use a protic solvent as the second solvent. This makes the first solvent compatible with the second solvent. Further, the second solvent is preferably a solvent having a boiling point higher than a boiling point of the first solvent.

The second treatment solution may contain a plurality of second solvents, or may further contain another solvent different from the second solvent. Examples of the solvent different from the second solvent also include the same solvents as exemplified for the first solvent. One or a combination of two or more of these solvents may be contained. The second treatment solution may also contain a solute. Examples of the solute include acids such as carboxylic acid, sulfonic acid, phosphoric acid, and boric acid, and salts of these acids.

The second treatment solution is preferably applied to capacitor element 10 in an amount ranging from 200 parts by mass to 1000 parts by mass (both inclusive) relative to 100 parts by mass of the conductive polymer applied to capacitor element 10. This condition allows the conductive polymer particles to easily reach the dielectric layer.

The step of applying the first treatment solution to the surface of the dielectric layer (second step), the step of applying the second treatment solution to the surface of the dielectric layer (third step), and a fourth step (see description below) conducted as necessary may be, as a series of steps, repeated two or more times. By conducting this series of steps a plurality of times, a coverage of the conductive polymer particles on the dielectric layer can be increased. Alternatively, the repetition may be conducted step by step. For example, the third step (further the fourth step) may be conducted after the second step is conducted a plurality of times.

### (iv) Step of Removing at Least Part of Solvent (Fourth Step)

After the third step, at least a part of the first solvent and/or the second solvent included in the electrolytic capacitor may be removed from the viewpoint of an attachment property of the conductive polymer particles. An amount of the first solvent and/or the second solvent to be removed is not particularly limited. Particularly, when the first solvent is water, it is preferable that the water as the first solvent be removed almost completely. When the first solvent is vaporized by heating, a heating temperature may be higher than a boiling point of the first solvent, and preferably ranges from 50° C. to 300° C. (both inclusive), particularly preferably from 100° C. to 200° C. (both inclusive), for example.

As described above, the conductive polymer layer that is attached to cover at least a part of the surface of the dielectric layer is formed between anode body 21 and cathode body 22. At this time, the conductive polymer layer may cover not only the surface of the dielectric layer but also at least a part of the surface of cathode body 22 and/or the surface of separator 23. The conductive polymer layer formed on the surface of the dielectric layer practically functions as a cathode material.

(v) Step of Impregnating Conductive Polymer Layer-Including Capacitor Element with Electrolyte Solution (Fifth Step)

The capacitor element, in which conductive polymer has been formed by the steps described above, may be impregnated with the electrolyte solution. Thereby, a repair function of the dielectric layer is improved, and an ESR reduction effect can further be improved.

The electrolyte solution may be a nonaqueous solvent or a mixture of a nonaqueous solvent with an ionic substance (solute, e.g. an organic salt) dissolved in the nonaqueous solvent. The nonaqueous solvent may be an organic solvent or an ionic liquid. The nonaqueous solvent is preferably a solvent having a high boiling point. Examples of the nonaqueous solvent to be used include polyalcohols such as ethylene glycol, propylene glycol, and polyethylene glycol (PEG); cyclic sulfones such as sulfolane (SL); lactones such as γ-butyrolactone (yBL); amides such as N-methylacetamide, N,N-dimethylformamide, and N-methyl-2-pyrrolidone; esters such as methyl acetate; ethers such as 1,4-dioxane; ketones such as methyl ethyl ketone; and formaldehyde.

The organic salt is a salt in which at least one of an anion and a cation includes organic matter. Examples of the organic salt to be used include trimethylamine maleate, triethylamine borodisalicylate, ethyldimethylamine phthalate, mono 1,2,3,4-tetramethylimidazolinium phthalate, and mono 1,3-dimethyl-2-ethylimidazolinium phthalate.

A method for impregnating the capacitor element with the electrolyte solution is not particularly limited. Examples of the usable method include a method for immersing the capacitor element in the electrolyte solution contained in a vessel and a method for dropping the electrolyte solution onto the capacitor element. The impregnation may be conducted in an atmosphere under a reduced pressure ranging, for example, from 10 kPa to 100 kPa (both inclusive), preferably from 40 kPa to 100 kPa (both inclusive).

### (vi) Step of Sealing Conductive Polymer Layer-Including Capacitor Element (Sixth Step)

Next, the capacitor element, in which the conductive polymer layer has been formed, is sealed. Specifically, first, the capacitor element, in which the conductive polymer layer has been formed, is housed in bottomed case 11 so that lead wires 14A, 14B are positioned on an open upper surface of bottomed case 11. As a material of bottomed case 11, there can be used metals such as aluminum, stainless steel, copper, iron, and brass, or alloys of these metals.

Next, sealing member 12 formed so as to allow lead wires 14A, 14B to penetrate the sealing member is disposed above the capacitor element, in which the conductive polymer layer has been formed, to seal the capacitor element in bottomed case 11. Sealing member 12 has only to be an insulating substance. As the insulating substance, an elastic body is preferable, and for example, a high heat resistance silicone rubber, fluororubber, ethylene propylene rubber, Hypalon rubber, butyl rubber or isoprene rubber is especially preferable.

Next, bottomed case 11 is, at a part near an opening end, processed by transverse drawing, and is, at the opening end, swaged to sealing member 12 for curling. Last, base plate 13 is disposed on the curled part of the bottomed case to complete the sealing. Then, an aging treatment may be performed while a rated voltage is applied.

In the exemplary embodiment described above, a wound electrolytic capacitor has been described. The application range of the present disclosure, however, is not limited to the wound electrolytic capacitor, and the present disclosure can be applied to other electrolytic capacitors such as a chip electrolytic capacitor including a metal sintered body as an anode body, and a laminated electrolytic capacitor including a metal plate as an anode body.

### EXAMPLES

Hereinafter, the present disclosure is described in more detail with reference to examples. The present disclosure, however, is not limited to the examples.

### Example 1

In the present example, produced was a wound electrolytic capacitor (Φ6.3 mm×L (length) 5.8 mm) having a rated voltage of 35V and a rated electrostatic capacitance of 47 μF. Hereinafter, a specific method for manufacturing an electrolytic capacitor is described.

### (Anode Body Preparation Step)

A 100-μm-thick aluminum foil piece was subjected to etching to roughen a surface of the aluminum foil. Then, a dielectric layer was formed on the surface of the aluminum foil by an anodizing treatment. The anodizing treatment was conducted by immersing the aluminum foil in an ammonium adipate solution, followed by application of a voltage of 60 V.

### (Cathode Body Preparation Step)

A 50-μm-thick aluminum foil piece was subjected to etching to roughen a surface of the aluminum foil.

### (Separator Preparation Step)

Used as a separator was a cellulose separator which was made of a cellulose nonwoven fabric made from wood pulp and had a thickness of 50 μm and an air permeability of 10 s/100 ml.

### (Capacitor Element Production)

An anode lead tab and a cathode lead tab were connected to the anode body and the cathode body, respectively, and the anode body and the cathode body were would with the separator interposed between the anode body and the cathode body with the lead tabs being rolled in the anode body, the cathode body and the separator, to give a capacitor element. Ends of the lead tabs protruding from the capacitor element were connected to an anode lead wire and a cathode lead wire, respectively. Then, the produced capacitor element was subjected to an anodizing treatment again to form a dielectric layer at a cut end of the anode body. Next, an end of an outer surface of the capacitor element was fixed with a fastening tape.

(Impregnation with First Treatment Solution)

A mixed solution was prepared by dissolving 3,4-ethylene dioxythiophene and a dopant, polystyrenesulfonic acid, in ion-exchanged water (first solvent). Ferric sulfate and sodium persulfate dissolved in ion-exchanged water were added to the resultant mixed solution while the mixed solution was stirred, to cause a polymerization reaction. After the reaction, a resultant reaction solution was dialyzed to remove unreacted monomers and an excessive oxidizing agent so that a first treatment solution was obtained, which included a dispersion liquid containing polyethylene dioxythiophene doped with about 5% by mass of polystyrenesulfonic acid. The median diameter of the conductive polymer particles was 181 nm in a volume particle size distribution obtained by measurement with a particle diameter measuring apparatus (Zetasizer Nano ZS manufactured by Malvern Instruments Ltd.) according to dynamic light scattering.

Then, the capacitor element was impregnated with the resultant first treatment solution for 5 minutes.

(Impregnation with Second Treatment Solution)

PEG, γBL, and EG were prepared as a second solvent, and mixed in a mass ratio of 50:25:25 to prepare a second treatment solution. The capacitor element including a remaining first treatment solution was impregnated with the resultant second treatment solution. At this time, almost all of the first treatment solution applied was remained. The second treatment solution was applied in an amount of about 500 to 700 parts by mass relative to 100 parts by mass of the conductive polymer applied to the capacitor element. Next, the capacitor element, which has been impregnated with the second treatment solution, was dried at 150° C. for 30 minutes to form a conductive polymer layer in the capacitor element.

(Impregnation with Electrolyte Solution)

The conductive polymer layer-including capacitor element was impregnated with an electrolyte solution obtained by mixing PEG, γBL, SL, and amine phthalate (solute) in a mass ratio of 25:25:25:25.

### (Capacitor Element Sealing Step)

The capacitor element, which has been impregnated with the electrolyte solution, was housed in an outer case as shown in FIG. 1 and sealed to produce an electrolytic capacitor.

For the resultant electrolytic capacitor, electrostatic capacitance, ESR, and leakage current (LC) were measured, and a short circuit rate was calculated. Results are shown in Table 1. The short circuit rate is a proportion of samples that caused a short circuit to 300 samples, and the other characteristics were obtained as an average value of the samples other than the samples that caused a short circuit.

### Example 2

An electrolytic capacitor was produced in the same manner as in Example 1 except that the capacitor element was impregnated with the first treatment solution and dried in a drying furnace at 60° C. for 10 minutes, and the electrolytic capacitor was evaluated. Results are shown in Table 1. A remaining amount of the first solvent in the capacitor element after the drying was 51% by mass of the first solvent applied.

### Example 3

An electrolytic capacitor was produced in the same manner as in Example 1 except that a median diameter of conductive polymer particles contained in the first treatment solution was 80 nm in a volume particle size distribution, and the electrolytic capacitor was evaluated. Results are shown in Table 1.

### Example 4

An electrolytic capacitor was produced in the same manner as in Example 1 except that a median diameter of conductive polymer particles contained in the first treatment solution was 53 nm in a volume particle size distribution, and the electrolytic capacitor was evaluated. Results are shown in Table 1.

### Comparative Example 1

An electrolytic capacitor was produced in the same manner as in Example 1 except that used as the separator was a synthetic fiber separator that was made of a polyester nonwoven fabric and had a thickness of 50 μm and an air permeability of 0.9 s/100 ml, and the electrolytic capacitor was evaluated. Results are shown in Table 1.

### Comparative Example 2

An electrolytic capacitor was produced in the same manner as in Example 1 except that the capacitor element was not impregnated with the second treatment solution, and the electrolytic capacitor was evaluated. Results are shown in Table 1.

TABLE 1

| | Electrostatic | | | Short circuit |
|---|---|---|---|---|
| | capacitance (μF) | ESR (mΩ) | LC (μA) | rate (%) |
| Example 1 | 41.9 | 25.1 | 0.52 | 0 |
| Example 2 | 40.1 | 26.5 | 2.29 | 2.1 |
| Example 3 | 41.2 | 24.3 | 0.89 | 0 |
| Example 4 | 42.0 | 24.1 | 3.11 | 1.9 |
| Comparative | 41.8 | 23.8 | 5.21 | 14 |
| Example 1 | | | | |
| Comparative | 27.5 | 64.3 | 12.21 | 42 |
| Example 2 | | | | |

In Examples 1 to 4, the leakage current (LC) and the short circuit rate were very small. It is considered that this is because the conductive polymer particles reached a surface of the dielectric layer, and the conductive polymer layer was formed on the surface of the dielectric layer. Particularly in Examples 1 to 3 in which used were the conductive polymer particles having a median diameter of 80 nm or more in a volume particle size distribution, the leakage current (LC) and the short circuit rate were small.

In Comparative Example 1, although adequate electrostatic capacitance was obtained, the leakage current (LC) and the short circuit rate were large because a separator having a very high air permeability (large meshes) was used. In Comparative Example 1, a synthetic fiber was used as a material of the separator. In view of these facts, the present exemplary embodiment can be said to particularly exhibit the effects when a separator including cellulose is used. In Comparative Example 2, the electrostatic capacitance was small, and the ESR, LC, and short circuit rate were large. It is considered that this is because the conductive polymer particles could not reach a surface of the dielectric layer.

### Example 5

An electrolytic capacitor was produced in the same manner as in Example 1 except that used as the separator was a cellulose separator that was made of a cellulose nonwoven fabric made from rayon and had a thickness of 50 μm and an air permeability of 130 s/100 ml, and the electrolytic capacitor was evaluated. Results are shown in Table 2.

### Example 6

An electrolytic capacitor was produced in the same manner as in Example 1 except that used as the separator was a cellulose separator that was made of a cellulose nonwoven fabric made from kraft pulp and had a thickness of 50 μm and an air permeability of 21.1 s/100 ml, and the electrolytic capacitor was evaluated. Results are shown in Table 2.

### Example 7

An electrolytic capacitor was produced in the same manner as in Example 1 except that used as the separator was a cellulose separator that was made of a cellulose nonwoven fabric made from hemp and had a thickness of 50 μm and an air permeability of 6.2 s/100 ml, and the electrolytic capacitor was evaluated. Results are shown in Table 2.

### Example 8

An electrolytic capacitor was produced in the same manner as in Example 1 except that used as the separator was a cellulose separator that was made of a cellulose nonwoven fabric made from Manila hemp and esparto and had a thickness of 50 μm and an air permeability of 1.6 s/100 ml, and the electrolytic capacitor was evaluated. Results are shown in Table 2.

### Example 9

An electrolytic capacitor was produced in the same manner as in Example 1 except that used as the separator was a nonwoven fabric mixed separator (thickness: 50 μm, air permeability 5.0 s/100 ml) obtained by mixing a cellulose fiber, which was made from wood pulp, with a polyester fiber in a mass ratio of cellulose fiber/polyester fiber of 70/30, and the electrolytic capacitor was evaluated. Results are shown in Table 2.

TABLE 2

| | Electrostatic | | | Short circuit |
|---|---|---|---|---|
| | capacitance (μF) | ESR (mΩ) | LC (μA) | rate (%) |
| Example 5 | 39.6 | 27.2 | 0.53 | 0 |
| Example 6 | 40.8 | 25.8 | 0.55 | 0 |
| Example 7 | 41.9 | 24.9 | 0.55 | 0 |
| Example 8 | 42.1 | 25.1 | 0.68 | 0 |
| Example 9 | 42.2 | 24.1 | 0.58 | 0 |

As is understood from Table 2, even when the cellulose separators having a low air permeability (compact separators of fine meshes) were used, the electrolytic capacitors in Examples 5 to 9 showed large electrostatic capacitance, and small ESR, LC, and short circuit rate. That is, it is understood that the conductive polymer particles reached a surface of the dielectric layer also in these cases.

The present disclosure can be used in an electrolytic capacitor including a conductive polymer layer as a cathode material.

What is claimed is:

1. A method for manufacturing an electrolytic capacitor, the method comprising:
preparing a capacitor element that includes an anode body having a dielectric layer, and a separator including a cellulose fiber;
impregnating the capacitor element with a first treatment solution containing a first solvent and conductive polymer particles; and
impregnating, after impregnating the capacitor element with the first treatment solution, the capacitor element with a second treatment solution containing a second solvent at a state where the capacitor element includes the first solvent.

2. The method for manufacturing the electrolytic capacitor according to claim 1, wherein the capacitor element is impregnated with the second treatment solution at a state where the capacitor element includes 30% by mass or more of the first solvent impregnated into the capacitor element when the capacitor element is impregnated with the first treatment solution.

3. The method for manufacturing the electrolytic capacitor according to claim 1, wherein a median diameter of the conductive polymer particles which is measured by dynamic light scattering is 80 nm or more.

4. The method for manufacturing the electrolytic capacitor according to claim 1, wherein the separator has an air permeability ranging from 1 s/100 ml to 150 s/100 ml both inclusive.

5. The method for manufacturing the electrolytic capacitor according to claim 1, wherein at least a part of at least one of the first solvent and the second solvent is removed from the capacitor element after impregnating the capacitor element with the second treatment solution.

6. The method for manufacturing the electrolytic capacitor according to claim 1, wherein the first solvent is water.

7. The method for manufacturing the electrolytic capacitor according to claim 1, the method further comprising impregnating the capacitor element with an electrolyte solution after impregnating the capacitor element with the second treatment solution.
